(19) United States
(12) Patent Application Publication
(10) Pub. No.: US 2025/0119496 A1
(43) Pub. Date: Apr. 10, 2025

(54) METHODS AND SYSTEMS FOR CALL MANAGEMENT

(71) Applicant: Comcast Cable Communications, LLC, Philadelphia, PA (US)

(72) Inventors: Vengatarajulu Rajasekar, Moorestown, NJ (US); Eric Wong, Moorestown, NJ (US); Alex F. Model, Moorestown, NJ (US)

(21) Appl. No.: 18/483,177

(22) Filed: Oct. 9, 2023

(51) Int. Cl. H04M 3/436; G10L 15/26; H04M 3/42

(52) U.S. Cl. CPC H04M 3/436; G10L 15/26; H04M 3/42042

(57) ABSTRACT

Methods and systems for call management are described. Rich call data may be inserted into an outgoing call. The rich call data may be determined based on one or more voice inputs. The rich call data may be configured to provide additional information about the call to the intended recipient.

### BACKGROUND

A rise in spam calls has led to an increase in phone users ignoring calls from unknown numbers. This behavior is driven by a desire to reduce exposure to scams, annoyance, and wasted time. In the case of legitimate calls from unknown numbers there is a lack of capability for callers to provide additional information to the intended recipient, and thereby increase the chances the intended recipient will answer the call from the unknown number. Recipients ignoring legitimate calls solely because the recipient does not recognize the number leads to business losses, service interruptions, and other problems.

### SUMMARY

It is to be understood that both the following general description and the following detailed description are exemplary and explanatory only and are not restrictive. Methods and systems for call management are described. Rich call data may be inserted into an outgoing call. The rich call data may be determined based on one or more voice inputs. The rich call data may be configured to provide additional information about the call to an intended recipient.

### BRIEF DESCRIPTION OF THE DRAWINGS

The accompanying drawings, which are incorporated in and constitute a part of this specification, show examples and together with the description, serve to explain the principles:

FIGS. 1A-1B show an example system;

FIG. 2 shows an example system;

FIG. 3 shows an example method;

FIG. 4 shows an example method;

FIG. 5 shows an example method;

FIG. 6 shows an example method; and

FIG. 7 shows an example system for call management.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. If such a range is expressed, another configuration includes from the one particular value and/or to the other particular value. Similarly, if values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is to be understood that if combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information.” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

The present methods and systems provide an improvement in interactive content and related technologies by automatically launching one or more application, automatically navigating to one or more websites, and/or automatically accessing content without user intervention. Previously, users had to interact with user devices such as smart phones to manually enter web addresses displayed in content, scan QR codes or other similar techniques. The use of one or more inaudible signals to trigger the one or more applications, navigate to one or more websites, or access content improves computing efficiency and eliminates redundancies.

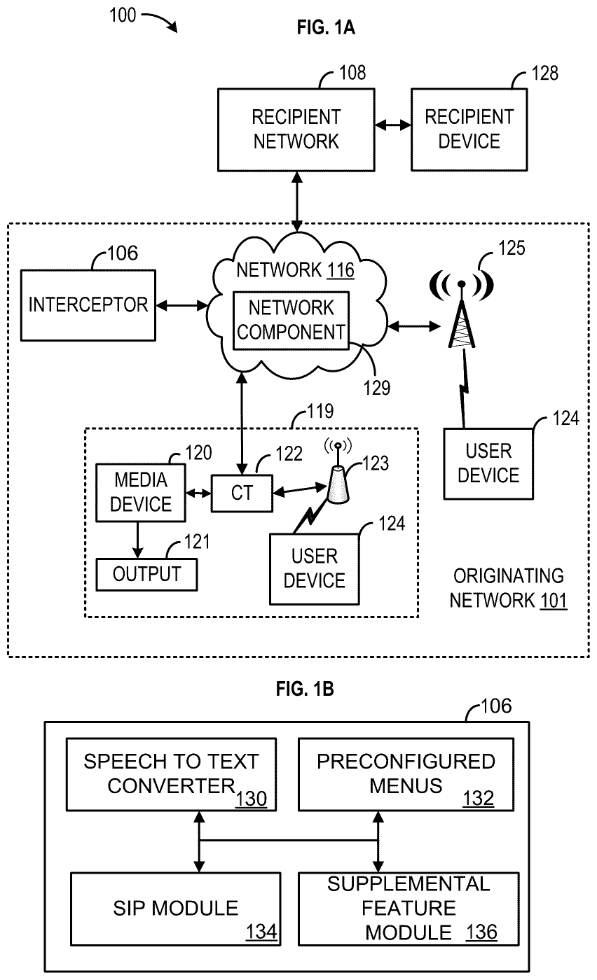

FIG. 1 shows a system 100 for call management. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise an originating network 101, a recipient network 108, and one or more intermediary networks. Although network 116 is shown in the originating network, the illustration is merely exemplary and explanatory and not limiting. For example, the network 116 may be an intermediary network (e.g., a transit network) between the originating network and the recipient network. The system 100 may comprise a user device 124 in the originating network and a recipient device 128 associated with the recipient network 108. The network may comprise a media device 120, an output device 121, a communications terminal 122, a first access point 123, a second access point 125 (e.g., a headend, fiber optic, or satellite communications facility), various other devices, combinations thereof, and the like.

The network 116 may facilitate sending data to and from the various devices of the system 100. The network 116 may be a telecommunications network, a content delivery network, a content access network, combinations thereof, and the like. The network may be managed (e.g., deployed, serviced) by a content provider, a service provider, combinations thereof, and the like. The network 116 may be an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like.

The user device 124 may comprise one or more of a cell phone, a smart phone, a laptop computer, a desktop computer, a tablet, a virtual assistant device, a plain old telephone (POTS), combinations thereof and the like. The intermediary device may be the interceptor device 106. The user device 124 may be configured to place an outgoing call. For example, a user may interact with the user device to place the outgoing call. For example, the outgoing call may be placed automatically in response to a wake word or other similar trigger. The outgoing call may be bound for a recipient device. The recipient device may be associated with the recipient network (e.g., the recipient network 108). The outgoing call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The interceptor device 106 may detect the outgoing call. A communication channel may be established between the intermediary device and the user device. The communication channel between the intermediary device and the user device may be established based on the intermediary device detecting the outgoing call. One or more outputs may be caused at the user device. The one or more outputs may be configured to solicit one or more user inputs from a user of the user device. The one or more outputs may be caused to be output via the communication channel between the intermediary device and the user device. The one or more outputs may comprise one or more voice prompts (e.g., questions, complete the statements, etc. . . . ). The one or more outputs may comprise one or more fillable forms. The one or more outputs may comprise one or more prompts. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.” The one or more outputs may be associated with one or more pre-configured menus.

The interceptor device 106 may determine one or more call types associated with the outgoing call. The one or more call types may comprise, for example, a legitimate call type and/or a spam call type. For example, the intercept device may determine the one or more call types based on one or more identifiers associated with the device placing the outgoing call, one or more identifiers associated with a user of the device placing the outgoing call, one or more numbers (e.g., phone numbers) associated with the device placing the outgoing call, one or more identifiers associated with the device receiving the outgoing call, one or more identifiers associated with a user of the device receiving the outgoing call, one or more numbers (e.g., phone numbers) associated with the device receiving the outgoing call, combinations thereof, or the like. For example, the interceptor device 106 may determine the outgoing call is from a user device associated with a number on an authorized list and may intercept the call to facilitate the collection of data to insert into the call as Rich Call Data. For example, the intercept device 106 may determine the outgoing call is a spam call type based on the one or more identifiers. Based on determining the outgoing call is a spam call, the interceptor device 106 may not intercept the spam call. Based on determining the outgoing call is a spam call, the interceptor device 106 may insert one or more preconfigure rich call data into the spam call (e.g., a notification the call may be spam).

One or more user inputs may be received. The one or more user inputs may be received based on the one or more outputs output at the user device configured to solicit the one or more inputs from the user of the user device. The one or more user inputs comprise one or more voice inputs (e.g., voice responses). The one or more user inputs may comprise one or more text inputs. The one or more user inputs may comprise one or more image inputs (e.g., one or more images captured via an image capture device such as a camera of a smartphone). The one or more user inputs may be converted to rich call data. The one or more user inputs may be converted to rich call data via speech to text conversion. The rich call data may be encoded into the outgoing call. The rich call data may be inserted into the outgoing call and configured to be output on the recipient device. The rich call data may be inserted into the outgoing call before the outgoing call leaves an originating network before entering the recipient network. The rich call data may be inserted, for example, into one or more fields of a session initiation protocol (SIP) invite. The rich call data may be output via the recipient device. For example, the rich call data may comprise the responses to the one or more outputs (e.g., the user inputs received in response to the one or more prompts) so as to convey additional information to the recipient of the call.

Returning to the components of system 100, the media device 120 may be configured to receive content and other associated data (e.g., the metadata). The media device 120 may comprise a user device such as an STB, computer, mobile phone, combinations thereof, and the like. The media device 120 may be a digital streaming device, a gaming device, a media storage device, a digital recording device, a computing device, a mobile computing device (e.g., a laptop, a smartphone, a tablet, etc.), combinations thereof, and the like.

The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication terminal 122, a computer, a TV, a monitor, or a satellite dish. The communication terminal 122 may be located at the user location 119. The communication terminal 122 may be configured to communicate with the network 116. The communication terminal 122 may be a modem (e.g., cable modem), a router, a gateway, a switch, a network terminal (e.g., optical network unit), combinations thereof, and the like. The communication terminal 122 may be configured for communication with the network 116 via a variety of protocols, such as IP, transmission control protocol, file transfer protocol, session initiation protocol, voice over IP (e.g., VoIP), combinations thereof, and the like. The communication terminal 122, for a cable network, may be configured to facilitate network access via a variety of communication protocols and standards, such as Data Over Cable Service Interface Specification (DOCSIS).

A first access point 123 (e.g., a wireless access point) may be located at the user location 119. The first access point 123 may be configured to provide one or more wireless networks in at least a portion of the user location 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the communication terminal 122, the media device 120, and the display device 121 may be implemented as a single device.

The user location 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

FIG. 1B shows an example diagram of one or more components of the interceptor device 106. The interceptor device 106 may comprise a speech to text converter 130. The speech to text converter may be configured to convert speech to text. For example, the speech to text converter may receive one or more user inputs. The one or more user inputs may be one or more audio inputs (e.g., voice inputs), one or more text inputs (e.g., typed responses to the one or more prompts), or one or more image inputs (e.g., one or more images captured by the user device based on the one or more prompts). The one or more user inputs may be received (e.g., recorded) in response to the one or more outputs. The one or more outputs may be sent to the user device. The one or more prompts may be configured to solicit one or more user inputs from a user of the user device. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.” The one or more outputs may be associated with one or more pre-configured menus.

The interceptor device 106 may store one or more preconfigured menus 132. The one or more preconfigured menus may be associated with one or more user profiles. For example, the interceptor device 106 may determine the outgoing call is associated with a user profile. For example, the interceptor device 106 may determine the outgoing call is associated with a user profile based on one or more identifiers associated with the outgoing call (e.g., a phone number, user ID, device ID, combinations thereof, and the like). The interceptor module may be configured to determine the outgoing call is associated with a user profile based on one or more response (e.g., the one or more user inputs). For example, a user may indicate the user is calling on behalf of a particular company. The speech to text converter may convert the response to text (e.g., to determine the company name). The preconfigured menus module may determine, based on the company name, one or more preconfigured menus.

The interceptor device 106 may comprise an SIP module 134. The SIP module may be configured to add, remove, edit, store, or otherwise process data to be included or excluded from an SIP invite according to RFC protocols. For example, the SIP module 134 may be configured to populate one or more SIP invite data fields with the text generated based on the user responses to the one or more prompts.

The interceptor device 106 may comprise a supplemental feature module 136. The supplemental feature module 136 may be configured to determine, generate, receive, send, or otherwise process or provide one or more supplemental features. The one or more supplemental features may comprise, for example, one or more images (e.g., one or more logos, one or more pictures, etc), one or more hyperlinks, one or more applications or applets, one or more gifs, one or more advertisements, one or more emojis, one or more short videos, combinations thereof and the like. The supplemental feature module 136 may be configured to activate or output, on the recipient device, the one or more supplemental features. For example, based on the text generated from the user inputs in response to the one or more prompts, the supplemental feature module may determine a logo associated with the company in the response, and cause output of the logo of the company at the recipient device. The aforementioned are merely exemplary and explanatory and are not intended to be limiting.

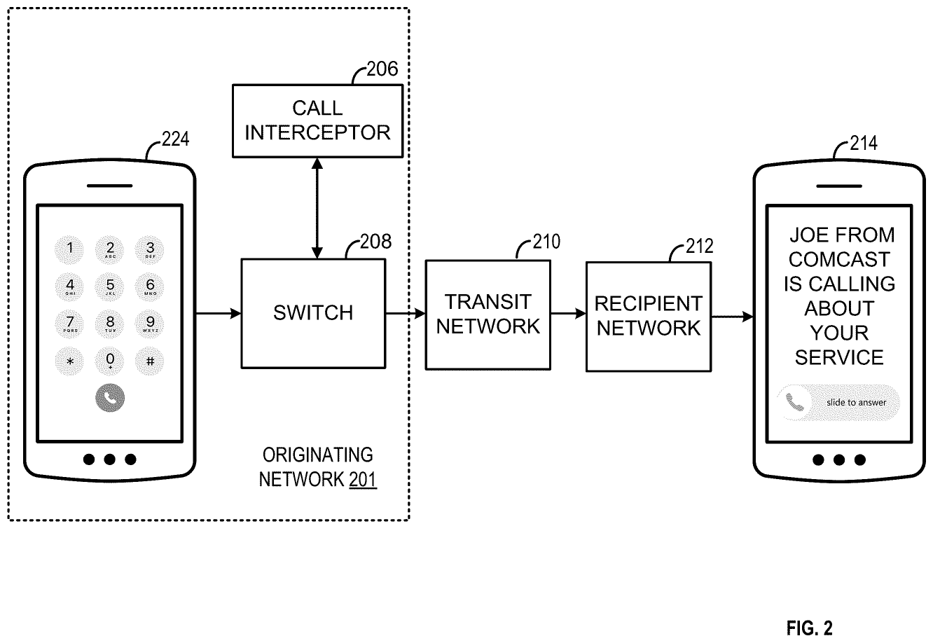

FIG. 2 shows an example system 200. The system 200 may comprise an originating network 201, a user device 224 (e.g., the mobile device 124), a switch 208, a call interceptor 206, a transit network 210, a recipient network 212, and a recipient device 214. The user device 224, the switch 208, and the call interceptor 206 may in the originating network 201. An outgoing call may be placed by user device 224. The outgoing call may be initiated by a user device (e.g., the mobile device 124). The user device may comprise one or more of a cell phone, a smart phone, a laptop computer, a desktop computer, a tablet, a virtual assistant, a plain old telephony (POTS) phone, combinations thereof, and the like.

The outgoing call may be detected by the switch 208. The switch 208 a switch may be a device within a telephone exchange, such as the public switched telephone network (PSTN), configured to connect calls from the requester to the destination. The switch 208 may be configured to detect a placed call, an “off-hook” condition, similar conditions and/or one or more signals related thereto. The outgoing call comprises one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The switch may route the call to the interceptor (e.g., the intermediary device 106). A communication channel may be established between the intermediary device and the user device. The communication channel between the intermediary device and the user device may be established based on the intermediary device detecting the outgoing call. The interceptor device 206 may cause one or more outputs to be output at the user device 224. The one or more outputs may be configured to solicit one or more user inputs from a user of the user device 224. The one or more outputs may be caused to be output via the communication channel between the intermediary device 206 and the user device 224. The one or more outputs may comprise one or more voice prompts (e.g., questions, complete the statements, etc.). The one or more outputs may comprise one or more prompts (e.g., one or more voice prompts). The one or more outputs may comprise one or more fillable forms. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.” The one or more outputs may be associated with one or more pre-configured menus.

Based on outputting the one or more outputs, one or more inputs may be received via a user interface of the user device 224. The user interface may comprise an audio interface (e.g., a microphone and related technologies). The user interface may comprise a touchscreen or other similar technologies. The one or more user inputs comprise one or more voice inputs (e.g., voice responses). The one or more user inputs may comprise one or more text inputs. The one or more user inputs may comprise one or more image inputs (e.g., one or more images captured via an image capture device such as a camera of a smartphone). The one or more user inputs may comprise responses to the one or more outputs. For example, after outputting the first prompt, “state your name,” a microphone on the user device 224 may be activated (e.g., for a period of time) to record a response. For example, a user may respond “Joe.” A second prompt may solicit more information from the user of the user device. For example, a second prompt may be, “what company do you work for?” A second user input may be a response such as “Comcast.” A third prompt may be “state the reason for your call.” A third user input in response to the third output may be, “I'm calling about the cable box.” The one or more user inputs (e.g., responses) may be formulaic (e.g., they may have the same format) or they may be freeform.

The one or more user inputs may be converted to rich call data. For example, the interceptor module may convert the one or more user inputs to rich call data via voice to text conversion. The one or more user inputs may be converted to rich call data via speech to text conversion. The rich call data may be encoded into the outgoing call. For example, the intermediary device may encode the data into an SIP invite using an identity header. The rich call data may be inserted into the outgoing call and configured to be output on the recipient device. The rich call data may be inserted into the outgoing call before the outgoing call leaves an originating network before entering the recipient network. The rich call data may be inserted, for example, into one or more fields of a session initiation protocol (SIP) invite. The call and the rich call data may exit the originating network and enter an intermediary network (e.g., transit network 210) and/or directly enter the recipient network 212 before being output on the recipient device 214. As shown in FIG. 2, the one or more user inputs that were converted to text and inserted into the SIP invite may be output on the recipient device before the recipient device answers (e.g., “picks up”) the call.

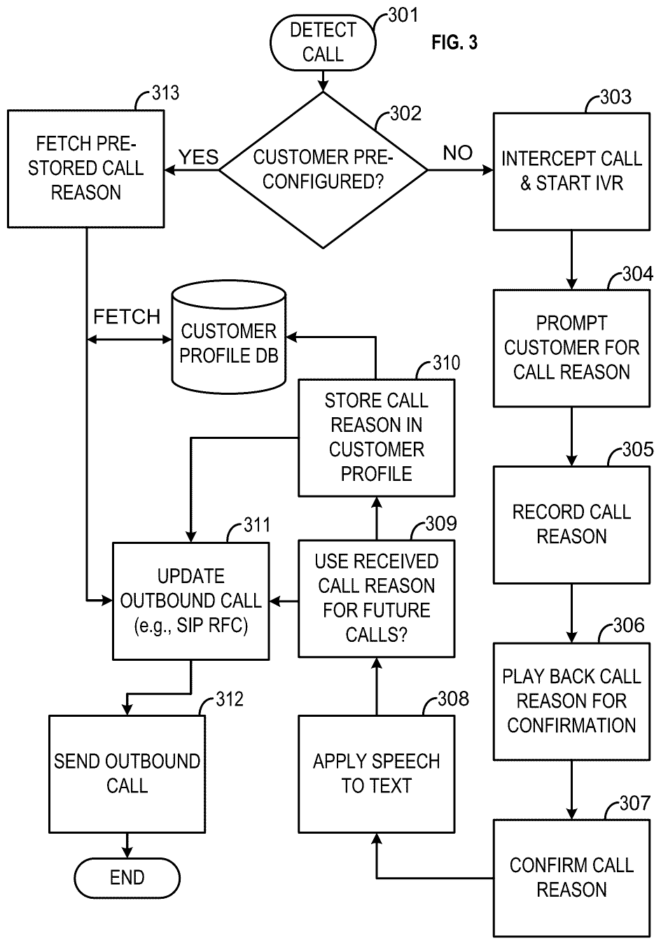

FIG. 3 shows a flowchart of an example method 300. The method may begin by detecting an outgoing call at 301. At 302, it may be determined whether the caller (e.g., the user device sending the outgoing call) is associated with a preconfigured menu or other service. For example, the outgoing call may comprise a user device ID and/or customer ID associated with the user device placing the call. The user device ID associated with the user device placing the call may be associated with a profile. The profile may be associated with a preconfigured service or menu stored in the customer profile database. If the user device ID or customer ID are associated with a profile comprising a preconfigured menu or preconfigured rich call data, the customer profile can be retrieved from a database and the preconfigured menu and/or preconfigured rich call data can be used to update the outbound call by, for example, including the rich call data in an SIP invite (e.g., step 311). The data may be added to the SIP invite via SIP RFC standards (RFC 2543, RFC 3261, STIR/SHAKEN protocols are incorporated herein in their entirety). If, however, the caller is not associated with a pre-configured profile, the method may proceed to step 303 where the call is ingested into an interactive voice response system (IVR) at 303. At 304, a user may be prompted for a call reason. For example, one or more outputs may be sent to and received by the user device. The one or more outputs may comprise one or more prompts. The one or more prompts may be received based on sending the outgoing call. The one or more prompts may be received from an intermediary device. The one or more prompts may be configured to be output on the user device. The one or more prompts may comprise one or more audible prompts (e.g., one or more voice prompts), one or more visual prompts (e.g., text prompts, image prompts). The one or more prompts may be configured to solicit one or more user inputs from a user of the user device. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.”

At 305, the responses to the one or more prompts may be recorded. At 306, the one or more responses to the one or more prompts may be played back to the user so the user can confirm the one or more responses are accurate. Optionally, the user may be presented with an option to re-record or otherwise resubmits the one or more user inputs. At 307, the user can confirm the call reason. At 308, the one or more recorded user inputs may be converted, via speech to text conversion, to text. At 309 a user may be asked whether they would like to use the recorded use inputs for future calls. If so, the one or more user inputs (e.g., the one or more call reasons) may be stored in a customer profile in the customer profile database at 310. At 311 the outbound call can be updated. For example, the rich call data can be inserted into the outbound call (e.g., into an SIP invite or other similar data).

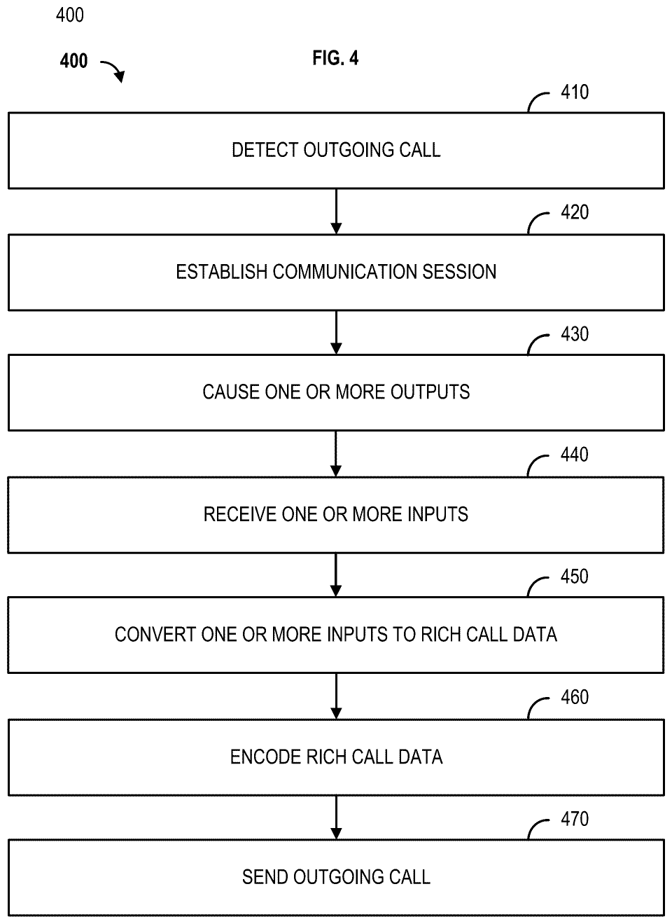

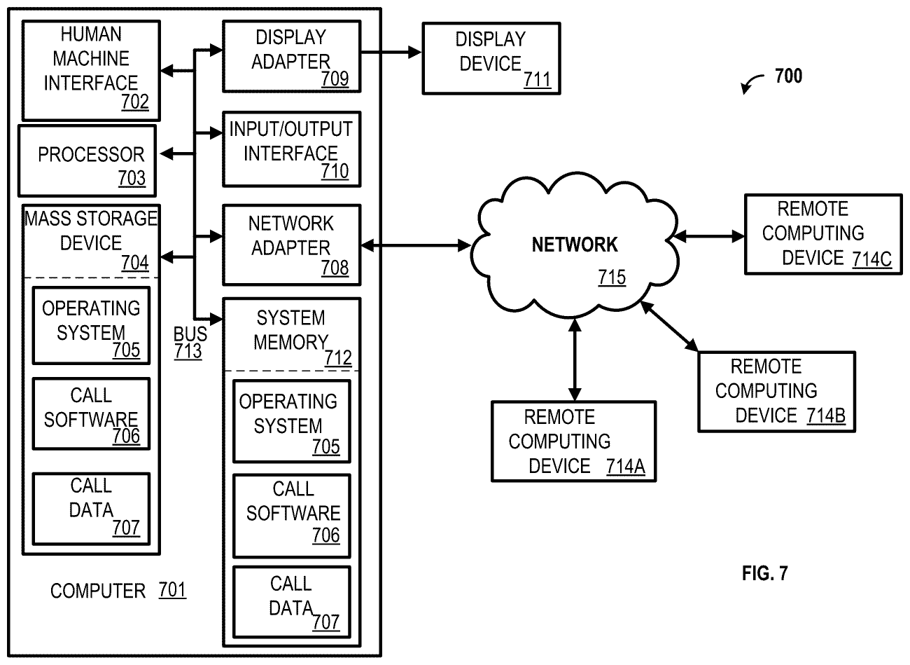

FIG. 4 shows a flowchart of a method 400. The method 400 may be carried out on any one or more of the devices described in FIG. 1, FIG. 2, and/or FIG. 7. At 410, an intermediary device may detect an outgoing call. The intermediary device may be part of an originating network (e.g., as opposed to a recipient network). The outgoing call may be initiated by a user device (e.g., the mobile device 124). The user device may comprise one or more of a cell phone, a smart phone, a laptop computer, a desktop computer, a tablet, a virtual assistant, a plain old telephony (POTS) phone, combinations thereof, and the like. The intermediary device may be the interceptor device 106. The outgoing call may be bound for a recipient device. The recipient device may be associated with the recipient network (e.g., the recipient network 108). The outgoing call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

At 420, a communication channel may be established between the intermediary device and the user device. The communication channel between the intermediary device and the user device may be established based on the intermediary device detecting the outgoing call.

At 430, one or more outputs may be caused at the user device. The one or more outputs may be configured to solicit one or more user inputs from a user of the user device. The one or more outputs may comprise one or more prompts. The one or more outputs may be caused to be output via the communication channel between the intermediary device and the user device. The one or more outputs may comprise one or more voice prompts (e.g., questions, complete the statements, etc.). The one or more outputs may comprise one or more fillable forms. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.” The one or more outputs may be associated with one or more pre-configured menus. For example, the user may have pre-stored images, text, or other data stored on the network configured to for Rich Call Data purposes. During an outgoing call, the intermediary device may prompt the user device to select which pre-stored images/text to use as RCD for a given call. Based on the input from the user device, the interceptor intermediary device may retrieve the specific pre-stored images/text to use as RCD for the call.

At 440, one or more user inputs may be received. The one or more user inputs may be received based on the one or more outputs output at the user device configured to solicit the one or more inputs from the user of the user device. The one or more user inputs comprise one or more voice inputs (e.g., voice responses). The one or more user inputs may comprise one or more text inputs. The one or more user inputs may comprise one or more image inputs (e.g., one or more images captured via an image capture device such as a camera of a smartphone).

At 450, the one or more user inputs may be converted to rich call data. The one or more user inputs may be converted to rich call data via speech to text conversion.

At 460, the rich call data may be encoded into the outgoing call. The rich call data may be inserted into the outgoing call and configured to be output on the recipient device. The rich call data may be inserted into the outgoing call before the outgoing call leaves an originating network before entering the recipient network. The rich call data may be inserted, for example, into one or more fields of a session initiation protocol (SIP) invite.

At 470, the outgoing call may be sent to the recipient network.

The method may comprise causing the recipient device to output the rich call data. The method may comprise detecting one or more prohibited user inputs. The one or more prohibited user inputs may comprise, for example, vulgar language, explicit images or text, combinations thereof, and the like. The method may comprise causing the one or more prohibited user inputs to not be output via the recipient device. The method may comprise outputting, based on detecting the one or more prohibited user inputs, one or more warnings on the user device.

The method may comprise sending, by a user device, towards a recipient network, an outgoing call. The method may comprise, based on sending the outgoing call, receiving, from an intermediary device, one or more prompts configured to solicit one or more user inputs. The method may comprise converting, via speech to text conversion, the one or more user inputs to rich call data. The method may comprise sending, towards the recipient network, the rich call data, wherein the rich call data is configured to be inserted into the outgoing call.

The method may comprise receiving, by a switch device, an outgoing call from a user device and bound for a recipient network; routing, to an intermediary device, the outgoing call; receiving, from the intermediary device, one or more prompts configured to solicit one or more user inputs; sending, to the user device, the one or more prompts; receiving, from the user device, based on the one or more prompts, the one or more user inputs; encoding, into the outgoing call, the one or more user inputs as rich call data; and causing the outgoing call and the rich call data to be sent.

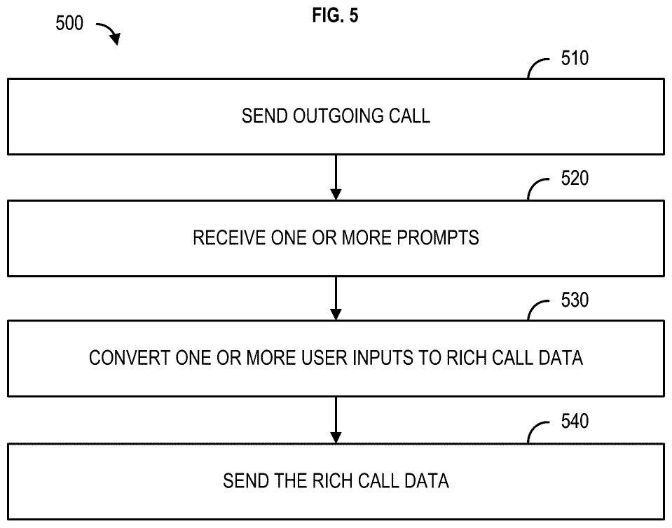

FIG. 5 shows an example method 500. The method 500 may be carried out on any one or more of the devices described in FIG. 1, FIG. 2, and/or FIG. 7. At 510, an outgoing may be sent towards a recipient network. The outgoing call may be sent towards a recipient device in the recipient network. The outgoing call may be placed by a user device. the outgoing call comprises one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call. The user device may be associated with an originating network. The user device may comprise one or more of a cell phone, a smart phone, a laptop computer, a desktop computer, a tablet, a virtual assistant, a plain old telephony (POTS) phone, combinations thereof, and the like.

At 520, one or more outputs may be received by the user device. The one or more outputs may comprise one or more prompts. The one or more prompts may be received based on sending the outgoing call. The one or more prompts may be received from an intermediary device. The one or more prompts may be configured to be output on the user device. The one or more prompts may comprise one or more audible prompts (e.g., one or more voice prompts), one or more visual prompts (e.g., text prompts, image prompts). The one or more prompts may be configured to solicit one or more user inputs from a user of the user device. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.” The one or more outputs may be associated with one or more pre-configured menus.

At 530, one or more user inputs may be received by the user device. The one or more user inputs may be one or more audio inputs (e.g., voice inputs), one or more text inputs (e.g., typed responses to the one or more prompts), or one or more image inputs (e.g., one or more images captured by the user device based on the one or more prompts).

At 540, the one or more user inputs may be converted to rich call data. The one or more user inputs may be converted to rich call data via speech to text conversion. The rich call data may be encoded into the outgoing call. The rich call data may be inserted into the outgoing call and configured to be output on the recipient device. The rich call data may be inserted into the outgoing call before the outgoing call leaves an originating network before entering the recipient network. The rich call data may be inserted, for example, into one or more fields of a session initiation protocol (SIP) invite.

At 550, the rich call data may be sent towards the recipient network. The rich call data may be configured to be inserted into the outgoing call.

The method may comprise causing the outgoing call to leave the originating network and enter a recipient network. The method may comprise causing output, via the recipient device, the rich call data.

The method may comprise detecting, by an intermediary device, an outgoing call initiated by a user device and bound for a recipient network; based on detecting the outgoing call, establishing a communication channel between the intermediary device and the user device; causing, at the user device, and via the communication channel between the intermediary device and the user device, one or more outputs configured to solicit one or more user inputs from a user of the user device; receiving, based on the one or more outputs, the one or more user inputs; converting, via speech to text conversion, the one or more user inputs to rich call data; encoding the rich call data into the outgoing call; and sending the outgoing call to the recipient network.

The method may comprise receiving, by a switch device, an outgoing call from a user device and bound for a recipient network; routing, to an intermediary device, the outgoing call; receiving, from the intermediary device, one or more prompts configured to solicit one or more user inputs; sending, to the user device, the one or more prompts; receiving, from the user device, based on the one or more prompts, the one or more user inputs; encoding, into the outgoing call, the one or more user inputs as rich call data; and causing the outgoing call and the rich call data to be sent.

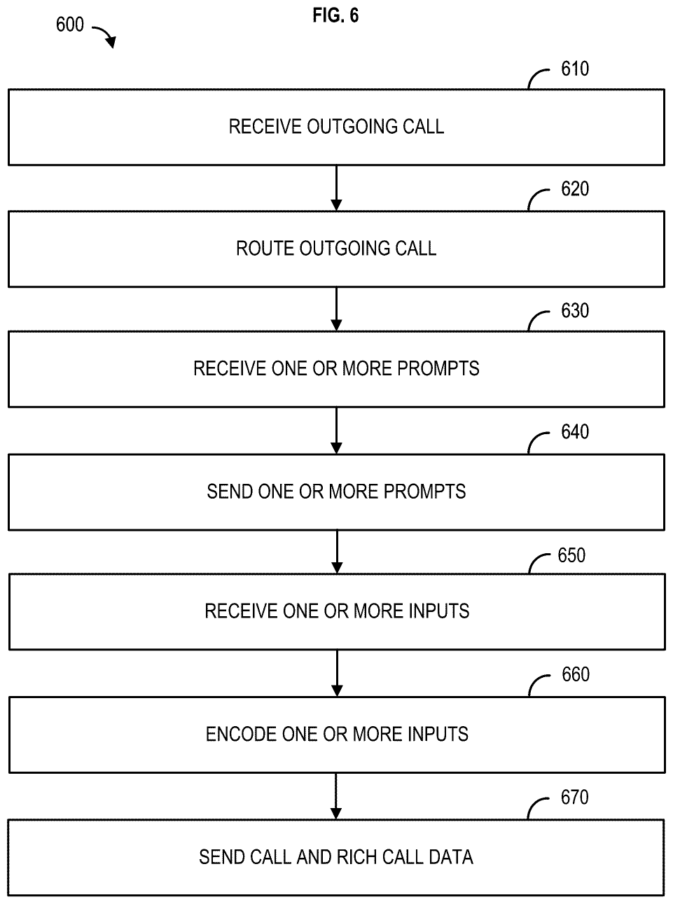

FIG. 6 shows an example method 600. The method 600 may be carried out on any one or more of the devices described in FIG. 1, FIG. 2, and/or FIG. 7. At step 610, an outgoing call may be received. The outgoing call may be received by a switch device. The outgoing call may be received from a user device. The user device may be associated with an originating network. The switch device may be associated with the originating network. The outgoing call may be bound for a recipient network. The outgoing call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

At 620, the outgoing call may be routed to an intermediary device. The intermediary device may comprise the interceptor device 106.

At 630, one or more outputs may be received by the switch. The one or more outputs may comprise one or more prompts. The one or more prompts may be received from an intermediary device. The one or more prompts may be configured to be output on the user device. The one or more prompts may comprise one or more audible prompts (e.g., one or more voice prompts), one or more visual prompts (e.g., text prompts, image prompts).

At 640, the one or more outputs may be sent to the user device. The one or more prompts may be configured to solicit one or more user inputs from a user of the user device. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.” The one or more outputs may be associated with one or more pre-configured menus.

At 650, one or more user inputs may be received by the user device. The one or more user inputs may be one or more audio inputs (e.g., voice inputs), one or more text inputs (e.g., typed responses to the one or more prompts), or one or more image inputs (e.g., one or more images captured by the user device based on the one or more prompts).

At 660, the one or more user inputs may be converted to rich call data. The one or more user inputs may be converted to rich call data via speech to text conversion. The rich call data may be encoded into the outgoing call. The rich call data may be inserted into the outgoing call and configured to be output on the recipient device. The rich call data may be inserted into the outgoing call before the outgoing call leaves an originating network before entering the recipient network. The rich call data may be inserted, for example, into one or more fields of a session initiation protocol (SIP) invite.

At 670, the call and the rich call data may be sent towards the recipient network. The rich call data may be configured to be inserted into the outgoing call.

The method may comprise causing the rich call data to be output via the recipient device. The method may comprise detecting, by an intermediary device, an outgoing call initiated by a user device and bound for a recipient network; based on detecting the outgoing call, establishing a communication channel between the intermediary device and the user device; causing, at the user device, and via the communication channel between the intermediary device and the user device, one or more outputs configured to solicit one or more user inputs from a user of the user device; receiving, based on the one or more outputs, the one or more user inputs; converting, via speech to text conversion, the one or more user inputs to rich call data; encoding the rich call data into the outgoing call; and sending the outgoing call to the recipient network

The method may comprise sending, by a user device, towards a recipient network, an outgoing call; based on sending the outgoing call, receiving, from an intermediary device, one or more prompts configured to solicit one or more user inputs; converting, via speech to text conversion, the one or more user inputs to rich call data; and sending, towards the recipient network, the rich call data, wherein the rich call data is configured to be inserted into the outgoing call

FIG. 7 shows a system 700 for call management. The media device 120, the output device 121, the communication terminal 122, the mobile device 124, the content source 102, the encoder 104, the one or more wagering services 108, and/or the network component 129 of FIG. 1 may be a computer 701 as shown in FIG. 7. The computer 701 may comprise one or more processors 703, a system memory 712, and a bus 713 that couples various system components including the one or more processors 703 to the system memory 712. In the case of multiple processors 703, the computer 701 may utilize parallel computing. The bus 713 is one or more of several possible types of bus structures, including a memory bus or memory controller, a peripheral bus, an accelerated graphics port, or local bus using any of a variety of bus architectures.

The computer 701 may operate on and/or comprise a variety of computer readable media (e.g., non-transitory). The readable media may be any available media that is accessible by the computer 701 and may comprise both volatile and non-volatile media, removable and non-removable media. The system memory 712 has computer readable media in the form of volatile memory, such as random access memory (RAM), and/or non-volatile memory, such as read only memory (ROM). The system memory 712 may store data such as the call data 707 and/or program modules such as the operating system 705 and the call software 706 that are accessible to and/or are operated on by the one or more processors 703. The machine learning module may comprise one or more of the call data 707 and/or the call software 706.

The computer 701 may also comprise other removable/non-removable, volatile/non-volatile computer storage media. FIG. 7 shows the mass storage device 704 which may facilitate non-volatile storage of computer code, computer readable instructions, data structures, program modules, and other data for the computer 701. The mass storage device 704 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 704, such as the operating system 705 and the call software 706. Each of the operating system 705 and the call software 706 (or some combination thereof) may comprise elements of the program modules and the call software 706. The call data 707 may also be stored on the mass storage device 704. The call data 707 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 715.

A user may enter commands and information into the computer 701 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 703 via a human machine interface 702 that is coupled to the bus 713, but may be connected by other interface and bus structures, such as a parallel port, game port, an IEEE 1394 Port (also known as a Firewire port), a serial port, network adapter 708, and/or a universal serial bus (USB).

The display device 711 may also be connected to the bus 713 via an interface, such as the display adapter 709. It is contemplated that the computer 701 may comprise more than one display adapter 709 and the computer 701 may comprise more than one display device 711. The display device 711 may be a monitor, an LCD (Liquid Crystal Display), light emitting diode (LED) display, television, smart lens, smart glass, and/or a projector. In addition to the display device 711, other output peripheral devices may be components such as speakers (not shown) and a printer (not shown) which may be connected to the computer 701 via the Input/Output Interface 710. Any step and/or result of the methods may be output (or caused to be output) in any form to an output device. Such output may be any form of visual representation, including, but not limited to, textual, graphical, animation, audio, tactile, and the like. The display device 711 and computer 701 may be part of one device, or separate devices.

The computer 701 may operate in a networked environment using logical connections to one or more remote computing devices 714A,B,C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 701 and a remote computing device 714A,B,C may be made via a network 715, such as a local area network (LAN) and/or a general wide area network (WAN). Such network connections may be through the network adapter 708. The network adapter 708 may be implemented in both wired and wireless environments. Such networking environments are conventional and commonplace in dwellings, offices, enterprise-wide computer networks, intranets, and the Internet.

Application programs and other executable program components such as the operating system 705 are shown herein as discrete blocks, although it is recognized that such programs and components reside at various times in different storage components of the computing device 701, and are executed by the one or more processors 703 of the computer. An implementation of the call software 706 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the quantity or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
detecting, by an intermediary device, an outgoing call initiated by a user device and bound for a recipient network;
based on detecting the outgoing call, establishing a communication channel between the intermediary device and the user device;
causing, at the user device, and via the communication channel between the intermediary device and the user device, one or more outputs configured to solicit one or more user inputs from a user of the user device;
receiving, based on the one or more outputs, the one or more user inputs;
converting the one or more user inputs to rich call data;
encoding the rich call data into the outgoing call; and
sending the outgoing call to the recipient network.

2. The method of claim 1, wherein the user device comprises one or more of: a cell phone, a plain old telephone system (POTS) device, a smart phone, a voice over internet protocol (VOIP) device, or a computer, and wherein the intermediary device is in an originating network.

3. The method of claim 1, wherein the one or more outputs comprise one or more prompts and wherein the one or more outputs are associated with one or more preconfigured menus and wherein the one or more user inputs comprise a caller, a reason for the call, a logo or a photo, and wherein the.

4. The method of claim 1, wherein the outgoing call comprises one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

5. The method of claim 1, wherein receiving the rich call data comprises:
receiving the one or more user inputs; and
converting the one or more user inputs, via voice to text conversion, the one or more user inputs to the rich call data.

6. The method of claim 1, further comprising causing a recipient device to output the rich call data.

7. The method of claim 1, further comprising:
detecting one or more prohibited user inputs; and
causing the one or more prohibited user inputs to not be output at a recipient device.

8. A method comprising:
sending, by a user device, towards a recipient network, an outgoing call;
based on sending the outgoing call, receiving, from an intermediary device, one or more outputs configured to solicit one or more user inputs;
converting the one or more user inputs to rich call data; and
sending, towards the recipient network, the rich call data, wherein the rich call data is configured to be inserted into the outgoing call.

9. The method of claim 8, wherein the user device comprises one or more of: a cell phone, a plain old telephone system (POTS) device, a smart phone, a voice over internet protocol (VOIP) device, or a computer, and wherein the intermediary device is in an originating network.

10. The method of claim 8, wherein the one or more outputs comprise one or more prompts and wherein the one or more outputs are associated with one or more preconfigured menus.

11. The method of claim 8, wherein the outgoing call comprises one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

12. The method of claim 8, wherein sending the rich call data comprises encoding, in the outgoing call, the one or more user inputs as the rich call data.

13. The method of claim 8, further comprising causing the outgoing call to leave an originating network and enter the recipient network.

14. The method of claim 8, further causing output at a recipient device the rich call data.

15. A method comprising:
receiving, by a switch device, an outgoing call from a user device and bound for a recipient network;
routing, to an intermediary device, the outgoing call;
receiving, from the intermediary device, one or more outputs configured to solicit one or more user inputs;
sending, to the user device, the one or more outputs;
receiving, from the user device, based on the one or more outputs, the one or more user inputs;
encoding, into the outgoing call, the one or more user inputs as rich call data; and
causing the outgoing call and the rich call data to be sent.

16. The method of claim 15, wherein the user device comprises one or more of: a cell phone, a plain old telephone system (POTS) device, a smart phone, a voice over internet protocol (VOIP) device, or a computer, and wherein the intermediary device is in an originating network.

17. The method of claim 15, wherein the intermediary device is in a call interceptor device, wherein the one or more outputs comprise one or more prompts and wherein the one or more outputs are associated with one or more preconfigured menus.

18. The method of claim 15, wherein the outgoing call comprises one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

19. The method of claim 15, wherein sending the one or more prompts comprises determining a preconfigured prompt menu associated with the user device.

20. The method of claim 15, further comprising causing the one or more user inputs to be output on a recipient device.
